(19) United States
(12) Patent Application Publication
(10) Pub. No.: US 2006/0135305 A1
(43) Pub. Date: Jun. 22, 2006

(54) Harmonic belt drive

(76) Inventors: Shmuel Erez, San Jose, CA (US); Ehood Geva, Palo Alto, CA (US)

Correspondence Address: Ehood Geva, 4190 Maybell Way, Palo Alto, CA, 94306, US

(21) Appl. No.: 11/010,657

(22) Filed: Dec. 13, 2004

(51) Int. Cl. F16G 1/28; F16H 7/06; F16G 5/20; F16G 9/00

(52) U.S. Cl. 474/202; 474/84; 474/87; 474/237; 474/156

(57) ABSTRACT

The present invention is a harmonic belt drive that uniquely combines desirable characteristics of a traditional harmonic drive with those of a traditional belt drive. The harmonic belt drive includes a rigid arcuate toothed member having an internal surface, an external surface, and a row of teeth radially extending from the internal surface and a belt portal extending between the internal surface and external surface. A multi-lobe cam is rotatably mounted concentric within the rigid toothed member and an elongated toothed belt is disposable between the multi-lobe cam and rigid arcuate toothed member. The toothed belt is radially deflectable by the multi-lobe cam meshing an area of belt teeth with an area of arcuate member teeth. The toothed belt advances by a small amount with each revolution of the multi-lobe cam.

### CROSS-REFERENCE TO RELATED APPLICATIONS

Not Applicable

### FEDERALLY SPONSORED RESEARCH

Not Applicable

### BACKGROUND OF THE INVENTION

1. Field of the Invention

The present invention relates to a belt drive mechanism that uniquely combines the desirable characteristics of a traditional harmonic drive mechanism with the desirable characteristics of a direct belt drive. In particular, the invention is a harmonic belt drive that directly advances an elongated belt useful for rotating or translating a mechanical load.

2. Description of Related Art

Harmonic drives and belt drives are well known in the art. Both have desirable properties that would be of great advantage to industry if properly combined. Harmonic drives have favorable properties such as nearly zero backlash and very high gear ratios as well as compact and lightweight construction.

Belt drives have the useful property of transferring mechanical power to remote offset loads. For example, the rotary motion of a rotating pulley mounted to the output shaft of a drive mechanism can be communicated to a remote torque load by way of a belt engaging both a pulley mounted to the input shaft of the torque load and the pulley connected to the output shaft of the drive mechanism. The following list of U.S. patents disclose various harmonic drive mechanisms or belt drive mechanisms:

| | |
|---|---|
| 2,906,143 | Musser |
| 5,749,800 | Nagel et al. |
| 6,250,179 | Shirasawa |
| 3,996,816 | Brighton |
| 4,934,212 | Hofmeister |
| 4,425,822 | Marschner et al. |
| 4,945,293 | Wittkopf et al. |

Of particular interest is U.S. Pat. No. 2,906,143 to C. W. Musser, which discloses the original harmonic drive. Harmonic drives have three main elements, a multi-lobe cam commonly referred to as a strain wave generator, an elastic radially deflectable gear known as a flexspline and a usually stationary gear known as a rigid circular spline or ring gear.

The modern configuration for a flexspline is that of a thin cup-shaped element having an outside, an inside, a closed end, an open end and an adjacent toothed portion arranged around the outside of the open end of the cup. The ring gear has internal radially extending teeth that have a slightly different pitch diameter from the teeth of the flexspline. The multi-lobe cam or wave generator is concentrically rotatable within the flexspline and the flexspline is concentrically rotatable within the ring gear. The lobes of the multi-lobe cam deflect the flexspline from the inside, meshing a number of flexspline teeth with a number of ring gear teeth. For each revolution of the strain wave generator the flexspline advances by a small number of teeth. Exceedingly high gear ratios can be achieved by proper selection of pitch diameter differential and flexspline deflection distance.

The output of a harmonic drive can be taken from either the flexspline or the ring gear. With the ring gear held stationary the flexspline is the driven element and a torque load is usually axially coupled to the closed end of the flexspline. Conversely, if the flexspline is held fast, the ring gear becomes the driven element and a torque load is coupled to it. One disadvantage, in either case, is that extra members such as belts, pulleys and couplings are necessary to transmit power to remote loads.

One attempt to combine the useful properties of the harmonic drive with that of a belt drive is presented in U.S. Pat. No. 5,749,800 to Nagel et al. The disclosure describes a synchronous belt drive having a toothed belt having two rows of teeth with different pitches. The toothed belt engages a driven wheel, a return wheel and two interconnected wheels secured against independent rotation. In contrast to the harmonic drive, the “gear ratio” of the synchronous belt is a function of belt length as well as tooth pitch. Also, the synchronous belt drive does not rely on a multi-lobe cam to mesh the teeth of the belt with any other element. A disadvantage of the synchronous belt drive is its larger number of key elements compared to the harmonic belt drive. What is needed is a belt drive mechanism that combines the desirable properties of both a harmonic drive and a belt drive while at the same time reducing the number of key elements needed with either technology.

### BRIEF SUMMARY OF THE INVENTION

The present invention addresses these needs by providing a unique belt drive that combines useful properties of a traditional harmonic drive mechanism with the useful remote load motion transfer capability of a traditional belt drive. For instance, the present invention retains the high gear ratio of a traditional harmonic drive mechanism while directly driving a belt coupled to a remote load. For the purposes of this disclosure the term teeth used herein means a series of equally spaced equally sized projections or indentions.

In general, the present invention is a harmonic belt drive that comprises a rigid arcuate toothed member having an internal surface, an external surface and a row of teeth radially extending from the internal surface. A belt portal extends through the arcuate toothed member connecting the internal and external surfaces of the arcuate toothed member.

A multi-lobe cam for driving a toothed belt is rotatably mounted concentric within the arcuate toothed member and an elongated toothed belt is disposable along a belt pathway between the multi-lobe cam and the arcuate toothed member. The toothed belt has an inside surface and an outside surface. Teeth on the belt's outside surface are meshable with the teeth on the inside surface of the arcuate toothed member. The inside surface of the belt may also include teeth useful for driving a toothed motion transfer device such as a toothed pulley coupled to a rotatable load.

Furthermore, the toothed belt is radially deflectable from its inside surface by the multi-lobe cam such that a contact patch or area containing a number of belt teeth is forced to mesh with a number of arcuate toothed member teeth. A slight difference in the number of teeth between the arcuate toothed member teeth meshing with belt teeth must exist in order to advance the position of the toothed belt relative to the arcuate toothed member. This difference exists in the number of teeth per area of contact or mesh created by the shorter distance between teeth contact points on the toothed belt relative to the distance between teeth contact points on the rigid arcuate toothed member, or vice versa.

The present invention has some similarities with a traditional harmonic drive mechanism. For example, the arcuate toothed member of the present invention functions much like the circular spline of a traditional harmonic drive. However, a major structural difference exists in that the arcuate toothed member of the present invention has a belt portal for the toothed belt to enter and exit the confines of the arcuate toothed member.

The portal is an opening that radially extends from the inside surface of the arcuate toothed member to the outside surface of the arcuate toothed member. The circular spline of a traditional harmonic drive has no equivalent portal.

Furthermore, the toothed belt of the present invention functions similar to the flexspline of a traditional harmonic drive. Here too, a major structural difference exists. The difference is that the total length of the toothed belt of the present invention can be many times longer than the length of the belt pathway situated adjacent the teeth of the arcuate toothed member, whereas the circumference of the flexspline is necessarily shorter than the inside circumference of the circular spline.

Another distinguishing feature of the present invention is its ability to transfer power to a load coupled directly to the enlongated belt. An example of such an application in which this feature can be utilized is with a garage door opener. Moreover, the toothed belt of the present invention does not need to be endless. In fact, the toothed belt of the present invention can have two ends, each adapted to attach to separate loads. For example, each end of the belt could be attached to separate loads pulled down by the force of gravity. This way, as the toothed belt is forced to move in one direction, one load ascends while the other load descends. In contrast, a traditional harmonic drive would be inoperable if its flexspline had ends.

In even greater contrast, the toothed belt of the present invention carries its teeth outside the confines of the arcuate toothed member in order to directly transfer motion to a remote mechanical load. The teeth of a flexspline in a traditional harmonic drive are always confined within the perimeter of the circular spline. Therefore, additional elements such as couplings and pulleys must be used in order to drive a load.

The multi-lobe cam of the present invention functions much the same as the multi-lobe cam or strain wave generator found in a traditional harmonic drive, both are designed to induce a strain wave in their respective toothed belt or flexspline. However, the multi-lobe cam of the present invention cannot have all the lobes of the multi-lobe cam deflecting the toothed belt at all times. The reason for this is that each lobe of the multi-lobe cam of the present invention must pass once per rotation within a space opened by the belt portal extending between the inside surface and outside surface of the arcuate toothed member. On the other hand, all the lobes belonging to a multi-lobe cam of a traditional harmonic drive mechanism must always deflect some portion of the drive's flexspline because the flexspline and multi-lobe cam are completely encompassed by a circular spline.

In operation, a motor or other prime mover rotates the multi-lobe cam. As the multi-lobe cam rotates, each lobe at some point in time enters the confines of the arcuate toothed member. While within the confines of the arcuate toothed member each lobe radially deflects a portion of the toothed belt against a number of teeth belonging to the arcuate toothed member. This action forces a patch or contact area of teeth belonging to the toothed belt to mesh with a patch of teeth belonging to the arcuate toothed member. As a result, the toothed belt forcefully advances through the belt pathway around the inside perimeter of the arcuate toothed member by a small number of teeth with each rotation of the multi-lobe cam. The toothed belt's direction of travel opposes the direction of rotation of the multi-lobe cam. The toothed belt enters and exits through the belt portal extending from the inside surface to the outside surface of the arcuate toothed member as the toothed belt advances around the inside perimeter of the arcuate toothed member. It has been determined that at least one idler pulley, preferably two, mounted on a faceplate above the belt portal can provide sufficient belt tension to prevent undesirable belt vibrations.

The toothed belt of the present invention is not limited to a toothed belt as defined in the normal sense. Instead, the toothed belt of the present invention can be a link chain like those used to anchor a ship or the toothed belt can be a small ball chain similar to those used to raise and lower household blinds. Moreover, it is possible that the toothed belt could have relatively smooth surfaces without discrete teeth. An example of such a belt would be grocery checkout conveyor belt like used with supermarket checkout counters. Such a belt would be forced by frictional forces between the arcuate toothed member and multi-lobe cam to advance through the belt pathway.

An important aspect of the invention is that sections of the toothed belt external the confines of the arcuate toothed member are used to directly put in motion remote mechanical loads. Such loads can be, but are not limited to printer print heads, scanners, household blinds, garage doors and electric windows in cars.

Another aspect of the invention is the ability to disengage the toothed belt from the arcuate toothed member for the purpose of freely moving the toothed belt through the belt pathway by a means other than rotation of the multi-lobe cam. One way to disengage the toothed belt from the arcuate toothed member is to retract one or more spring-loaded lobes of the multi-lobe cam. Another way is to separate the arcuate toothed member away from the belt and multi-lobe cam, thereby releasing the toothed belt allowing it to be pulled freely through the belt pathway.

Other aspects of the invention is its smaller size, fewer components, lower cost and simpler installation when compared to comparable prior art belt drives. Furthermore, in certain ultra-clean applications such as those found in the medical and semi-conductor industries, the present invention can be operated dry, i.e. without grease or oil lubricants. Dry operation of the invention also solves low viscosity lubrication problems that plague many prior art belt drives that must be able to operate in cold weather environments. Yet still other aspects of the present invention will become apparent to one skilled in the art upon a reading of the following detailed description of the invention, taken with the drawings.

### BRIEF DESCRIPTION OF THE DRAWINGS

FIG. 1 is a perspective view of the Harmonic Belt Drive with rollers in the engaged position.

FIG. 2 is an end view of the Harmonic Belt Drive with rollers in the disengaged position.

FIG. 3 is a perspective view of the Harmonic Belt Drive adapted to open and close automotive side windows.

### DETAILED DESCRIPTION OF THE PREFERRED EMBODIMENT

In the following description, terms such as left, right, top, bottom and the like are used solely for the purpose of clarity in illustrating the invention, and should not be taken as words of limitation. The drawings are for the purpose of illustrating the invention and are not intended to be to scale.

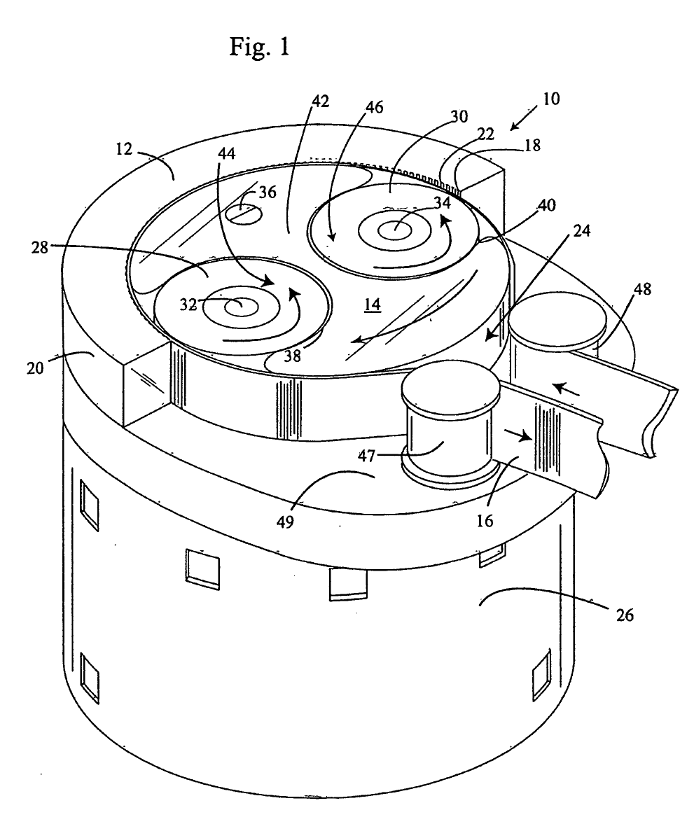

The present invention is a harmonic belt drive generally 10, shown in FIG. 1. The harmonic belt drive comprises a rigid arcuate toothed member 12, a multi-lobe cam 14 and an elongated toothed belt 16. Arcuate toothed member 12 has an internal surface 18 and an external surface 20. A row of teeth 22 radially extends from inner surface 18 and a belt portal 24 extends between internal surface 18 and external surface 20.

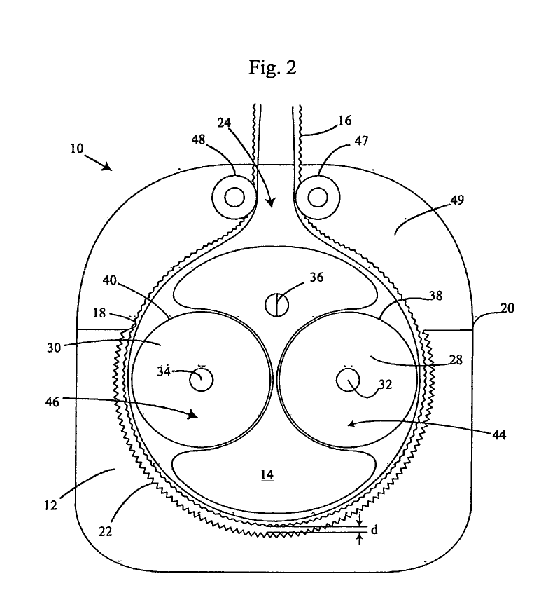

In the preferred embodiment, multi-lobe cam 14 is rotated by an electric motor 26. However, multi-lobe cam 14 can be driven by other prime movers such as an internal combustion engine, stepper motor or hand crank. Furthermore, in the preferred embodiment, multi-lobe cam 14 has a unique construction. Unlike the rigid elliptoidal multi-lobe cams used with traditional harmonic drive mechanisms, multi-lobe cam 14 of the present invention is constructed from an assembly that includes planetary rollers 28 and 30, rotatably mounted to axles 32 and 34 respectively. Rollers 28 and 30 have an engaged position and a disengaged position selectable by a selector switch 36 having an “on” position corresponding to the rollers engaged position and an “off” position corresponding to the rollers disengaged position. In the engaged position, rollers 28 and 30 are positioned to engage and deflect toothed belt 16. FIG. 2 shows rollers 28 and 30 in the disengaged position retracted from toothed belt 16. Whenever rollers 28 and 30 are in the disengaged position, toothed belt 16 can be pulled freely between multi-lobe cam 14 and arcuate toothed member 12. The ability to freely pull toothed belt 16 is a unique advantage allowing belt position to be adjusted quickly.

FIG. 1 shows selector switch 36 in the “on” position, locking rollers 28 and 30 in the engaged position. Whenever rollers 28 and 30 are in the engaged position, axles 32 and 34 are offset from the center of multi-lobe cam 14 by a predetermined amount dependant upon the diameters of rollers 28 and 30 as well as by deflection distance “d”. With rollers 28 and 30 in the engaged position, the centers of axles 32 and 34 are located at the foci of an elliptical pathway swept by the perimeter sidewalls 38 and 40 of rollers 28 and 30 as multi-lobe cam 14 is rotated. A belt retainer 42 having an oval profile includes a pair of circular cutouts 44 and 46 having diameters larger than planetary rollers 28 and 30. Belt retainer 42 is centered upon multi-lobe assembly 14 allowing circular cutouts 44 and 46 to partially encompass planetary rollers 28 and 30. Idler pulleys 47 and 48 rotatably mounted to a faceplate 49 add tension to belt 16 to prevent belt 16 from vibrating excessively. Faceplate 49 is attached to arcuate toothed member 12 extending beyond belt portal 24.

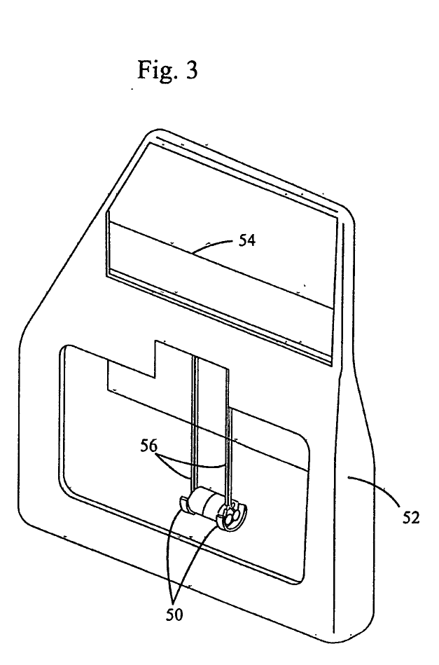

FIG. 3 shows a pair of harmonic belt drives 50 of the present invention installed inside a passenger car door 52 equipped with a power window 54. Harmonic belt drives 50 are powered by an electric motor 58. Toothed belts 56 motivated by harmonic drives 50 raise and lower power window 54.

In operation, multi-lobe cam 14 is rotated by motor 26. As multi-lobe cam 14 is rotated, the perimeter sidewalls 38 and 40 of rollers 28 and 30 radially deflect toothed belt 16. This action presses a patch of teeth 15 of toothed belt 16 against a patch of teeth 22 belonging to arcuate toothed member 12. As teeth 15 mesh with teeth 22, toothed belt 16 advances position by a small number of teeth dependent upon the gear ratio. Every rotation of multi-lobe cam 14 advances toothed belt 16 by a small amount resulting in a relatively slow but forceful progression of toothed belt 16 into and out of portal 24.

What is claimed is:

1. A harmonic belt drive comprising:
a) a rigid arcuate toothed member having an internal surface, an external surface, and a row of teeth radially extending from said internal surface and a belt portal extending between said internal surface and said external surface;
b) a multi-lobe cam rotatably mounted concentric within said rigid arcuate toothed member; and
c) an elongated toothed belt disposable between said multi-lobe cam and said rigid arcuate toothed member, said toothed belt being radially deflectable by said multi-lobe cam, said toothed belt having teeth meshable with the teeth of said rigid arcuate toothed member.

2. The harmonic belt drive of claim 1, wherein said multi-lobe cam is an assembly having a center flanked by a pair of planetary rollers rotatably mounted on axles, said planetary rollers each having a perimeter sidewall for engaging and radially deflecting said toothed belt.

3. The harmonic belt drive of claim 1, wherein each lobe of said multi-lobe cam alternately engages and disengages said toothed belt once per revolution of said multi-lobe cam.

4. The harmonic belt drive of claim 1, wherein a portion of said toothed belt extends through said portal extending between said internal surface and said external surface of said rigid arcuate toothed member.

5. The harmonic belt drive of claim 1, wherein a shorter distance exists between teeth contact points on the toothed belt relative to the distance between teeth contact points on the rigid arcuate toothed member.

6. The harmonic belt drive of claim 1, wherein said toothed belt has two ends.

7. The toothed belt of claim 6, wherein said two ends of said toothed belt are attachable to separate mechanical loads.

8. The harmonic belt drive of claim 1, wherein said toothed belt is significantly longer than the belt pathway situated between adjacent the teeth of said arcuate toothed member.

9. The harmonic belt drive of claim 1, wherein the direction of travel of said toothed belt opposes the direction of rotation of said multi-lobe cam.

10. A harmonic belt drive comprising:
a) a rigid arcuate toothed member having an internal surface, an external surface, and a row of teeth radially extending from said internal surface and a belt portal extending between said internal surface and said external surface;
b) a multi-lobe cam assembly rotatably mounted concentric to said rigid arcuate toothed member, said multi-lobe cam assembly having planetary rollers rotatably mounted on axles adjacent the center of said cam assembly, said planetary rollers each having a perimeter sidewall; and
c) an elongated toothed belt having an inside surface and an outside surface, said toothed belt being disposable between said multi-lobe cam and said rigid arcuate toothed member, said toothed belt being radially deflectable by said sidewalls, said toothed belt having teeth on its outside surface meshable with the teeth of said rigid arcuate toothed member.

11. The harmonic belt drive of claim 10, wherein said toothed belt has a length longer than the path swept by any lobe of said multi-lobe cam during one full rotation of said multi-lobe cam.

12. The harmonic belt drive of claim 10, wherein said toothed belt further includes teeth on its inside surface for engaging teeth on a load device.

13. The harmonic belt drive of claim 10, wherein said multi-lobe assembly further includes a belt retainer having an oval profile including circular cutouts having diameters larger than said planetary rollers, said belt retainer centered upon said multi-lobe assembly allowing the circular cutouts to partially encompass said planetary rollers.

14. A harmonic belt drive comprising:
a) a rigid arcuate toothed member having an internal surface, an external surface, and a row of teeth radially extending from said internal surface and a belt portal extending between said internal surface and said external surface;
b) a multi-lobe cam assembly rotatably mounted concentric to said rigid arcuate toothed member, said multi-lobe cam assembly having a pair of planetary rollers rotatably mounted on axles adjacent the center of said cam assembly, said planetary rollers each having a perimeter sidewall; and
c) an elongated toothed belt disposable between said multi-lobe cam and said rigid arcuate toothed member, said toothed belt being radially deflectable by said sidewalls, said toothed belt having teeth meshable with the teeth of said rigid arcuate toothed member.

15. The harmonic belt drive of claim 14, wherein at least one of said planetary rollers has an engaged position for radially deflecting said toothed belt and a disengaged position for preventing deflection of said toothed belt.

16. The planetary rollers of claim 15, wherein a selector switch having engaged and disengaged positions corresponding to said engaged and disengaged positions of said at least one planetary roller controls the engaged and disengaged positions of said at least one planetary roller.

17. The harmonic belt drive of claim 14, further including a faceplate mounted to said arcuate toothed member, said faceplate extending beyond said belt portal.

18. The faceplate of claim 17, further including at least one idler pulley rotatably mounted to said faceplate for applying tension to said belt.

19. The faceplate of claim 17, further including a pair of rotatably mounted idler pulleys wherein said pulleys engage the outside surface of said toothed belt to add tension to said belt.

20. The harmonic belt drive of claim 14, further including an electric motor for rotating said multi-lobe cam.
